(19) United States
(12) Patent Application Publication
(10) Pub. No.: US 2025/0378452 A1
(43) Pub. Date: Dec. 11, 2025

(54) Comprehension-Based Authorship Verification

(71) Applicant: Paul Maximilian Seufert, Los Angeles, CA (US)

(72) Inventor: Paul Maximilian Seufert, Los Angeles, CA (US)

(21) Appl. No.: 19/091,431

(22) Filed: Mar. 26, 2025

Related U.S. Application Data
(60) Provisional application No. 63/570,127, filed on Mar. 26, 2024.

(51) Int. Cl. G06Q 30/018

(52) U.S. Cl. CPC G06Q 30/018

(57) ABSTRACT

The method and system for comprehension-based authorship verification evaluates a user's response to determine how well the user comprehends their own submitted assignment. The user submits their assignment into a validation system where it is analyzed by a Large Language Model (LLM) to generate a question based on the assignment. The generated question is then presented to the user wherein the user provides a user response with a microphone, camera or keyboard. The user response is then analyzed by the LLM again to generate a score that ranks the level of comprehension the user has based on their submitted assignment. Each user response, question, score, and assignment are stored within a database and visually presented to an administrator, wherein the database highlights users that require more attention due to low scores.

### FIELD OF THE INVENTION

The present invention relates generally to Artificial Intelligence (AI) detection. More specifically, the present invention is a system and method of comprehension-based authorship verification.

### BACKGROUND OF THE INVENTION

Artificial intelligence (AI) has been rapidly improving and is becoming widely available for practical applications. Although AI has many benefits, it can also be a detriment to education as students have been known to use AI to plagiarize by generating completed assignments (e.g., essays, lab reports, computer code) instead of learning the subject matter themselves. It is an object of the present invention to address this issue by providing users with a system and method of comprehension-based authorship verification to help teachers detect AI usage by automatically determining how well students comprehend their own submitted assignments.

### BRIEF DESCRIPTION OF THE DRAWINGS

FIG. 1 is a flowchart of the method of the present invention.

FIG. 2 is a flowchart of a sub-method of the present invention.

FIG. 3 is a flowchart of a sub-method of the present invention.

FIG. 4 is a flowchart of a sub-method of the present invention.

FIG. 5 is a flowchart of a sub-method of the present invention.

FIG. 6 is a flowchart of a sub-method of the present invention.

FIG. 7 is a flowchart of a sub-method of the present invention.

FIG. 8 is a flowchart of a sub-method of the present invention.

FIG. 9 is a flowchart of a sub-method of the present invention.

FIG. 10 is a flowchart of a sub-method of the present invention.

FIG. 11 is a flowchart of a sub-method of the present invention.

FIG. 12 is a block diagram of the system of the present invention.

FIG. 13A is a flowchart of the method of the present invention.

FIG. 13B is a flowchart of the method of the present invention.

FIG. 13C is a flowchart of the method of the present invention.

### DETAILED DESCRIPTION OF THE INVENTION

All illustrations of the drawings are for the purpose of describing selected versions of the present invention and are not intended to limit the scope of the present invention.

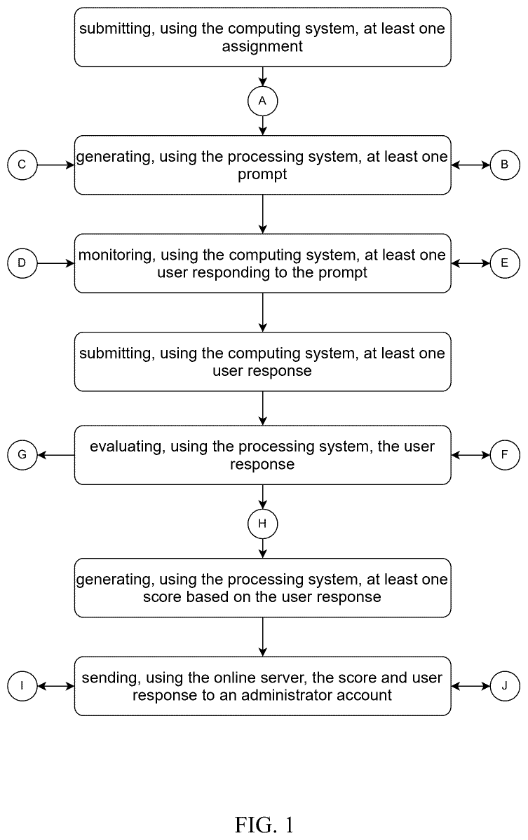

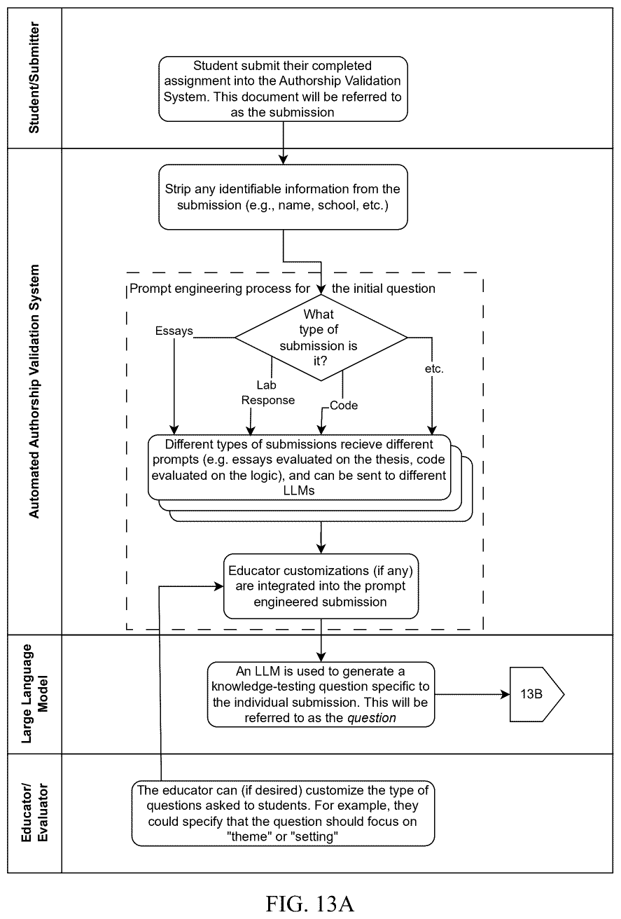

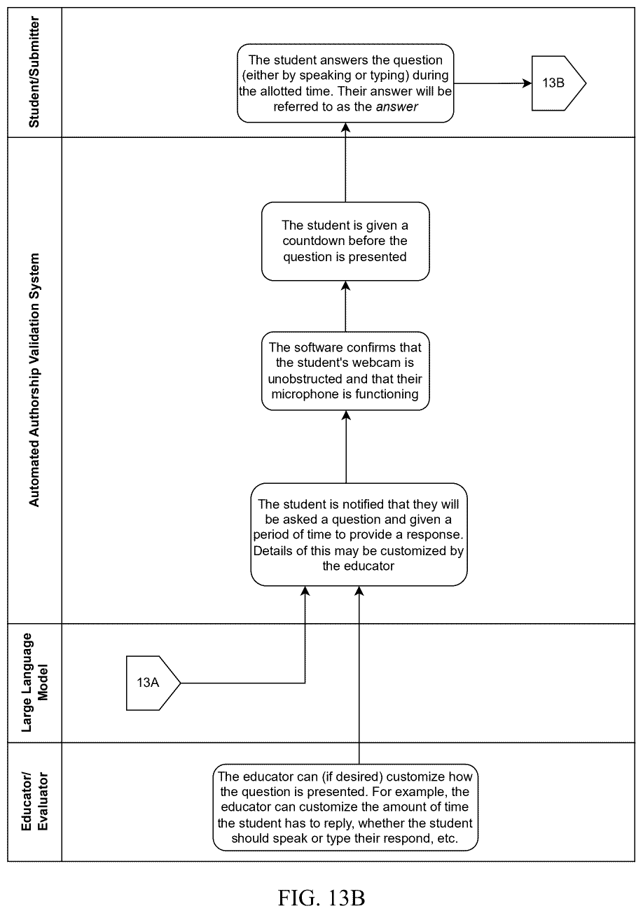

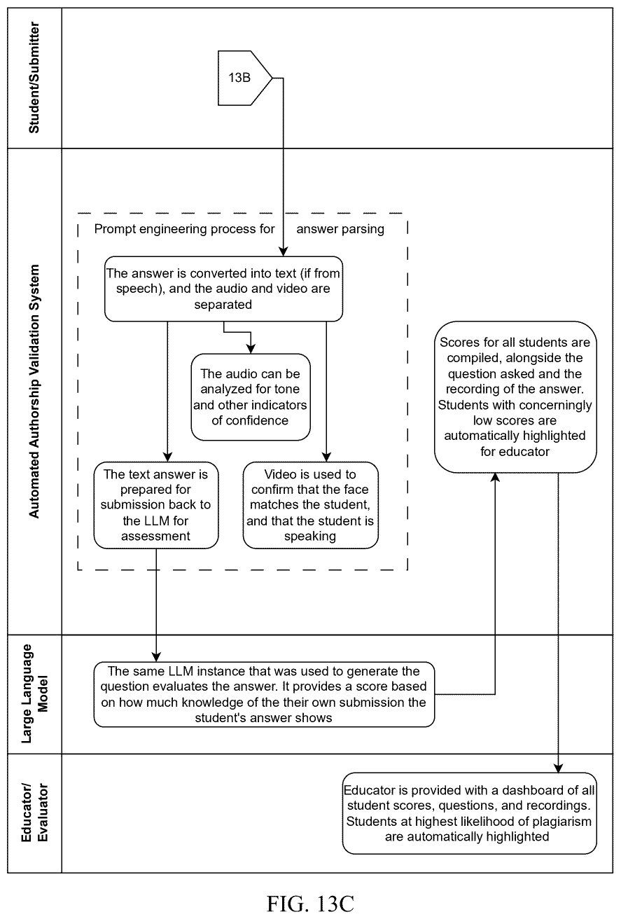

As can be seen in FIG. 1 through FIG. 13, the preferred embodiment of the present invention is a method for comprehension-based authorship verification. The method of the present invention detects the use of Artificial Intelligence (AI) to complete assignments 111 by checking a user's 4 comprehension of the assignment 111. For example, if a user 4 submits an assignment 111 to an administrator 3 on the history of the United States of America, the present invention will generate a question specific to the information within the user's 4 submitted assignment 111 to determine if they understand the material they are claiming to have written. In this way, the method of the present invention examines the user's 4 understanding of their submitted assignment 111.

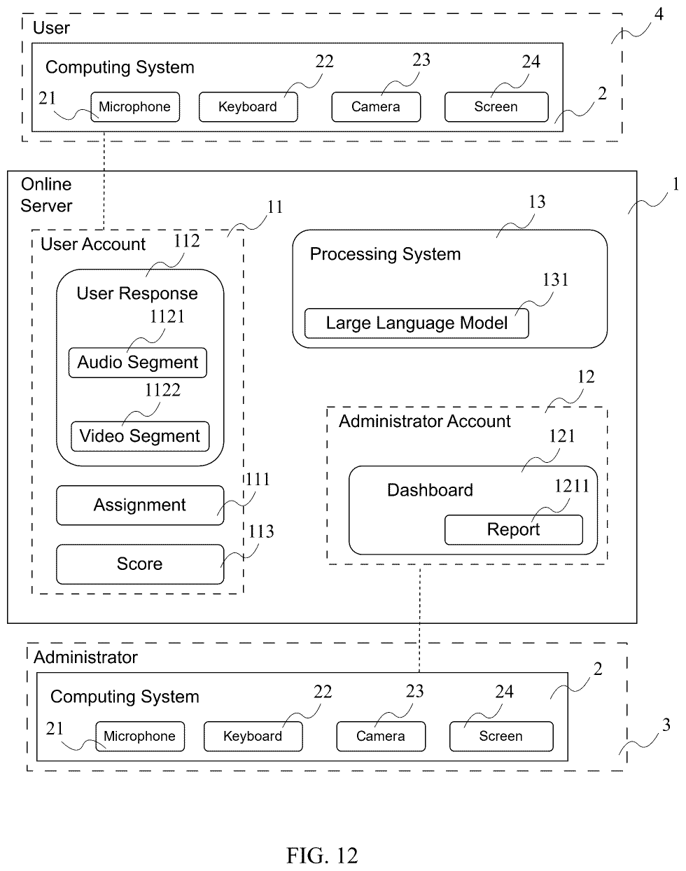

The system used to execute the method of the present invention allows the present invention to function as a system that checks user's 4 assignments 111 for comprehension-based authorship verification. FIG. 12, illustrates a block diagram of a system for comprehension-based authorship verification, in accordance with some embodiments. To accomplish this, the system of the present invention comprises an online server 1, at least one computing system 2, a user 4, and an administrator 3. The online server 1 is an online database that hosts a website that may be accessed by both the user 4 and administrator 3. The user 4 and administrator 3 accesses the online server 1 through each computing system 2. The computing system 2 is a device with internet capabilities that facilitates the user 4 and administrator 3 accessing the online server 1. The user 4 is a person or student who is submitting an assignment 111. The administrator 3 is a person or teacher who checks the comprehension of the user's 4 submitted assignment 111. Each computing system 2 is in remote communication with the online server 1. the online server 1 further comprises a user account 11, an administrator account 12 and a processing system 13. The user account 11 is associated with the user 4 wherein each user 4 may have their own user account 11. The administrator account 12 is associated with the administrator 3 wherein each administrator 3 may have their own administrator account 12. Each computing system 2 further comprises a microphone 21, a keyboard 22, a camera 23, and a screen 24. The microphone 21, keyboard 22, and camera 23 enables the user 4 to provide input to answer any question provided by the online server 1 and viewed through the screen 24 of the computing system 2. In continuation of the previous example the user 4 may utilize their user account 11, a microphone 21 and camera 23 to answer a question that is generated by the processing system 13 based on a user response 112.

As can be seen in FIG. 12, the system used to execute the method of the present invention allows the present invention to ask questions to the user 4 based on the user's 4 submitted assignment 111. To accomplish this, the user account 11 further comprises at least one assignment 111, at least one user response 112, and at least one score 113. The assignment 111 may be an essay, piece of code, lab work, or any other type of assignment 111 submission. The user response 112 is a spoken or typed answer to the prompt asked by the online server 1 based on the assignment 111. The score 113 is a numerical value between 1-100 that is generated based on the accuracy of the user response 112 with respect to the assignment 111. The higher the numerical value of the score 113 correlates with a higher user 4 understanding of the assignment 111. At least one response is retrieved through the computing system 2. The user 4 submits their user response 112 to the online server 1 with the computing system 2. Each user response 112 further comprises an audio segment 1121 and a video segment 1122. The administrator account 12 further comprises a dashboard 121. The dashboard 121 is a graphical user 4 interface that provides the administrator 3 with a visualization of the user 4 associated with the administrator 3 and each user response 112 and associated score 113. The processing system 13 further comprises a Large Language Model (LLM 131) which is utilized to generate a prompt to test user's 4 comprehension of the assignment 111 and to analyze the user response 112.

The present invention is a novel way to test if a student used generative Artificial Intelligence (AI) to complete their assignment 111 for them. Instead of attempting to detect generative AI by analyzing linguistic patterns (e.g., how predictable words are, how sentences are structured, how consistently patterns appear) in the completed assignment 111 itself, the present invention's method is to test the student to determine how much they comprehend their own submitted assignment 111.

The present invention leverages Large-Language-Models (LLMs 131) to automatically generate a knowledge-testing question for the student to answer. The student is required to respond to this question, and the LLM 131 then evaluates the student's response to determine how well they comprehend their own submission.

As can be seen in FIG. 1, the method of the present invention allows the present invention to function as a comprehension-based authorship verification. To accomplish this, the method of the present invention starts by submitting, using the computing system 2, at least one assignment 111. Next the method generates, using the processing system 13, at least one prompt. Then the method monitors, using the computing system 2, at least one user 4 responding to the prompt. Afterwards the method submits, using the computing system 2, at least one user response 112. Next the method evaluates, using the processing system 13, the user response 112. Later the method generates, using the processing system 13, at least one score 113 based on the user response 112. Finally, the method sends, using the online server 1, the score 113 and user response 112 to an administrator account 12. In continuation of the previous example once the student submits their history essay a question is generated based on the essay submitted, wherein the student verbally responds to the question and is graded based on that response. If the essay mentions the crossing of the Mayflower the system could ask the user “what was the name of the famous ship you mentioned that carried pilgrims to North America in 1620?”

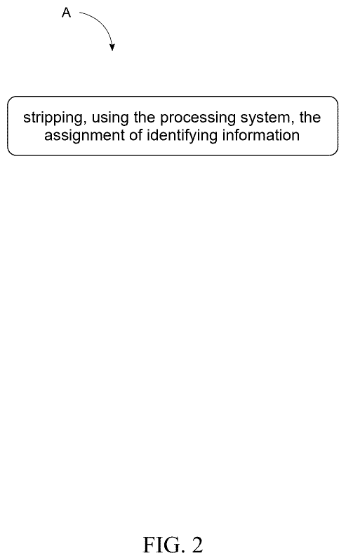

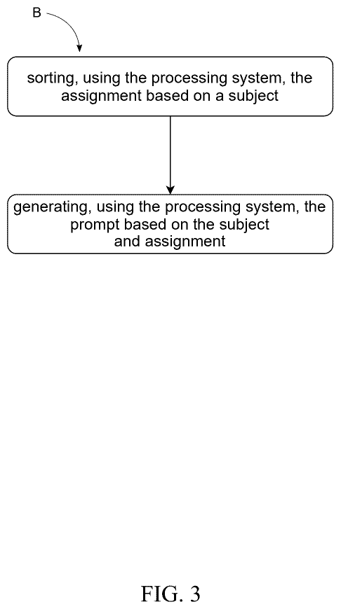

In reference to FIGS. 2 and 3, a sub-process of the method of the present invention enables a submitted assignment 111 to be processed and categorized. To that end, the sub-process begins by stripping, using the processing system 13, the assignment 111 of identifying information. Information such as the student's name, school, address, etc. are removed from the assignment 111 to ensure the resulting document only contains contents related to the assignment 111 topic.

The sub-process continues by sorting, using the processing system 13, the assignment 111 based on a subject. This enables different types of assignments 111 to receive different prompts wherein an assignment 111 may be essays, lab reports, code, or similar documents. The sub-process continues by generating, using the processing system 13, the prompt based on the subject and assignment 111. For example, this ensures that if an essay is submitted the generated prompt is evaluated on the thesis of the essay or if code is submitted the generated prompt is evaluated on the logic of the code.

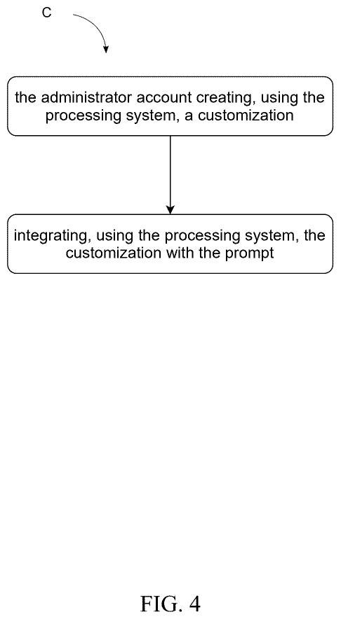

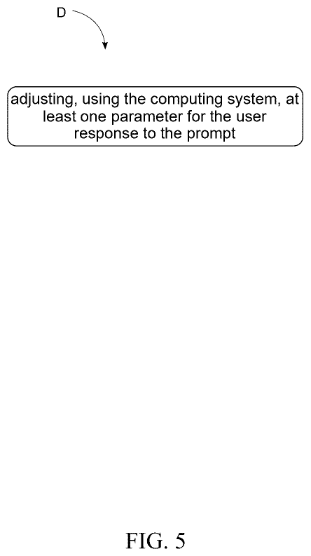

In reference to FIGS. 4 and 5, a sub-process of the method of the present invention enables administrators 3 to adjust the prompt to meet their teaching needs. To that end, the sub-process begins with the administrator account 12 creating, using the processing system 13, a customization. The customization is an optional choice the administrator 3 may take to tailor the prompt. For example, the administrator 3 may specify that the prompt should focus on a theme or setting. The sub-process continues by integrating, using the processing system 13, the customization with the prompt. This ensures that if a customization is made by the administrator 3, the customization is combined and integrated with the prompt that is generated by the processing system 13. The sub-process continues by adjusting, using the computing system 2, at least one parameter for the user response 112 to the prompt. The parameter controls how the prompt is presented to the user 4. For example, the administrator 3 may adjust the amount of time the user 4 has to reply, may dictate how the user 4 should respond to the prompt, etc. Returning again to the example, if the administrator 3 want more control over the prompt, they may tell the processing system 13 to focus the prompt on a specific year of history in the United States of America and allow the user (4) 45 seconds to respond by speaking.

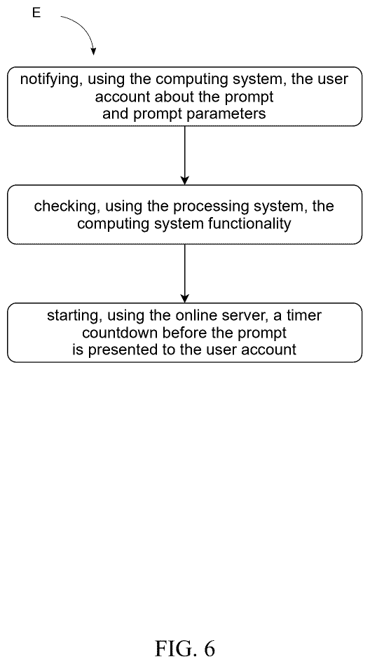

In reference to FIG. 6, a sub-process of the method of the present invention enables the present invention to present the user 4 with a prompt. To that end, the sub-process begins by notifying, using the computing system 2, the user account 11 about the prompt and each parameters. The user 4 is shown what type of prompt, how long they have to respond and how they must respond to the prompt. The sub-process continues by checking, using the processing system 13, the computing system 2 functionality. Before the prompt is shown to the user 4 the devices required to send a user response 112 are checked to make sure they are working such as the microphone 21, keyboard 22, or camera 23. The sub-process continues by starting, using the online server 1, a timer countdown before the prompt is presented to the user account 11. This ensures the user 4 answers the prompt within the allotted amount of time on the timer countdown.

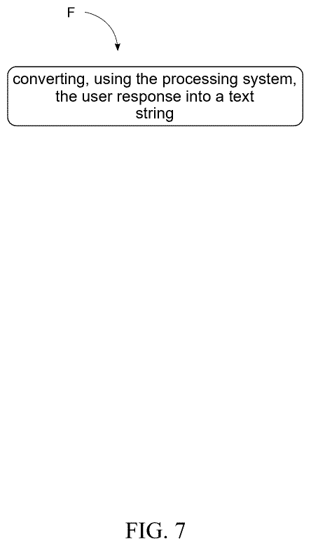

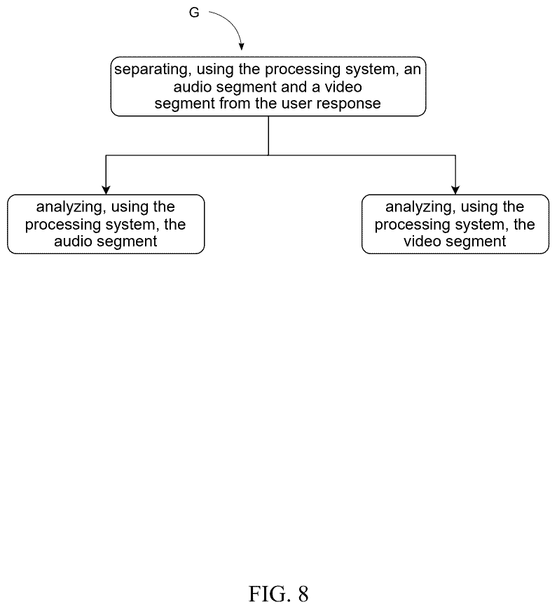

In reference to FIGS. 7 and 8, a sub-process of the method of the present invention enables the system to analyze the user response 112 to ensure the right user 4 is answering the prompt and to analyze user 4 comprehension. To that end, the sub-process begins by converting, using the processing system 13, the user response 112 into a text string. If the user 4 utilizes a microphone 21 and camera 23 to answer the prompt the user response 112 is recorded and converted to text. The sub-process continues by separating, using the processing system 13, an audio segment 1121 and a video segment 1122 from the user response 112. This enables the audio and video to be analyzed separately from the content of the user response 112. The sub-process continues by analyzing, using the processing system 13, the audio segment 1121. The audio segment 1121 may be analyzed for tone and other indicators of confidence. The sub-process continues by analyzing, using the processing system 13, the video segment 1122. The video segment 1122 may be analyzed to confirm that the face matches the user 4 and that the user 4 is the one speaking. Returning again to the example, when the user 4 is recorded giving a user response 112 to the history prompt the video segment 1122 could be analyzed to detect a facial expression that is not confident or detect off screen 24 reading.

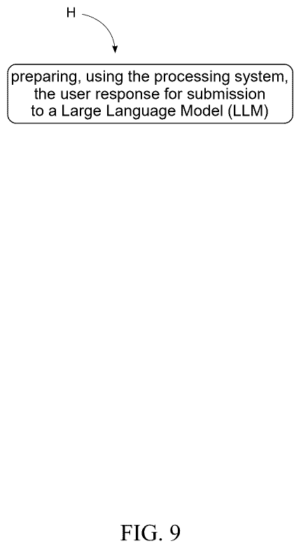

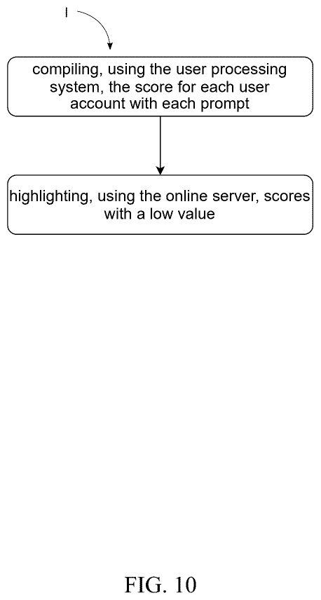

In reference to FIGS. 9 and 10, a sub-process of the method of the present invention enables the user response 112 to be analyzed wherein a score 113 to rate the comprehension level of the user 4 is generated. To that end, the sub-process begins by preparing, using the processing system 13, the user response 112 for submission to a Large Language Model (LLM 131). The same LLM 131 utilized to generate the prompt is utilized to analyze and evaluate the user response 112 to check comprehension. The sub-process continues by compiling, using the user 4 processing system 13, the score 113 for each user account 11 with each prompt. The score 113 is based on how much knowledge the user 4 has of their assignment 111 the user 4 shows in their user response 112. The sub-process continues by highlighting, using the online server 1, scores 113 with a low value. This enables the administrator 3 to easily pinpoint which user 4 may need to be analyzed more thoroughly to check for comprehension on their assignment 111. Returning again to the example, if the user 4 fails to properly answer the history prompt correctly with regards to their assignment 111 a low score 113 is generated, and the user 4 is highlighted within a dashboard 121 enabling the administrator 3 to easily see which user 4 needs more attention.

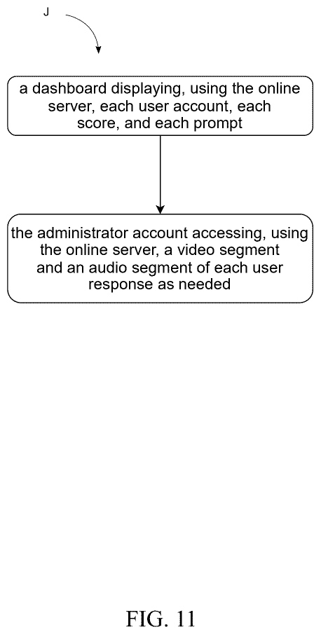

In reference to FIG. 11, a sub-process of the method of the present invention enables administrators 3 to have a visual summary of each user 4 and their comprehension of their assignment 111. To that end, the sub-process begins with a dashboard 121 displaying, using the online server 1, each user account 11, each score 113, and each prompt. A user account 11 with a high likelihood of plagiarism is automatically highlighted for the administrator 3 to see. The sub-process continues by the administrator account 12 accessing, using the online server 1, a video segment 1122 and an audio segment 1121 of each user response 112 as needed. This enables the administrator 3 to conduct a deeper dive into the specifics on the user response 112 and manually analyze which user 4 may have plagiarized their work due to their low comprehension of their own submitted assignment 111.

Although the invention has been explained in relation to its preferred embodiment, it is to be understood that many other possible modifications and variations can be made without departing from the spirit and scope of the invention as hereinafter claimed.

What is claimed is:

1. A method for comprehension-based authorship verification comprising:
submitting, using the computing system, at least one assignment;
generating, using the processing system, at least one prompt;
monitoring, using the computing system, at least one user responding to the prompt;
submitting, using the computing system, at least one user response;
evaluating, using the processing system, the user response;
generating, using the processing system, at least one score based on the user response; and
sending, using the online server, the score and user response to an administrator account.

2. The method for comprehension-based authorship verification as claimed in claim 1 comprising stripping, using the processing system, the assignment of identifying information.

3. The method for comprehension-based authorship verification as claimed in claim 1 comprising:
sorting, using the processing system, the assignment based on a subject; and
generating, using the processing system, the prompt based on the subject and assignment.

4. The method for comprehension-based authorship verification as claimed in claim 1 comprising:
the administrator account creating, using the processing system, a customization; and
integrating, using the processing system, the customization with the prompt.

5. The method for comprehension-based authorship verification as claimed in claim 1 comprising adjusting, using the computing system, at least one parameter for the user response to the prompt.

6. The method for comprehension-based authorship verification as claimed in claim 1 comprising:
notifying, using the computing system, the user account about the prompt and each parameter;
checking, using the processing system, the computing system functionality; and
starting, using the online server, a timer countdown before the prompt is presented to the user account.

7. The method for comprehension-based authorship verification as claimed in claim 1 comprising converting, using the processing system, the user response into a text string.

8. The method for comprehension-based authorship verification as claimed in claim 1 comprising separating, using the processing system, an audio segment and a video segment from the user response.

9. The method for comprehension-based authorship verification as claimed in claim 8 comprising:
analyzing, using the processing system, the audio segment; and
analyzing, using the processing system, the video segment.

10. The method for comprehension-based authorship verification as claimed in claim 1 comprising preparing, using the processing system, the user response for submission to a Large Language Model (LLM).

11. The method for comprehension-based authorship verification as claimed in claim 1 comprising:
compiling, using the user processing system, the score for each user account with each prompt; and
highlighting, using the online server, scores with a low value.

12. The method for comprehension-based authorship verification as claimed in claim 1 comprising:
a dashboard displaying, using the online server, each user account, each score, and each prompt; and
the administrator account accessing, using the online server, a video segment and an audio segment of each user response as needed.

13. A system for comprehension-based authorship verification comprising:
an online server;
at least one computing system;
a user;
an administrator;
each computing system being in remote communication with the online server;
the user and administrator accessing the online server through each computing system;
the online server further comprising a user account, an administrator account and a processing system;
each computing system further comprising a microphone, a keyboard, a camera, and a screen;
the user being associated with the user account; and
the administrator being associated with the administrator account.

14. The system for comprehension-based authorship verification as claimed in claim 13 comprising:
the user account further comprising at least one assignment, at least one user response, and at least one score;
at least one response being retrieved through the computing system;
the administrator account further comprising a dashboard; and
the processing system further comprising a Large Language Model (LLM).

15. The system for comprehension-based authorship verification as claimed in claim 14 wherein each user response further comprising an audio segment and a video segment.
